(19) United States
(12) Patent Application Publication
(10) Pub. No.: US 2015/0269662 A1
(43) Pub. Date: Sep. 24, 2015

(54) METHOD AND APPARATUS FOR VERIFYING A VALIDITY OF COMMUNICATION FROM A FRAUD DETECTION SERVICE

(71) Applicant: Xerox Corporation, Norwalk, CT (US)

(72) Inventors: BRYAN J. ROOF, Newark, NY (US); Andrew Shih-Suen Yeh, Portland, OR (US); Howard A. Mizes, Pittsford, NY (US); Haitao Du, Webster, NY (US)

(73) Assignee: Xerox Corporation, Norwalk, CT (US)

(21) Appl. No.: 14/218,681

(22) Filed: Mar. 18, 2014

(51) Int. Cl. G06Q 40/00; G06Q 50/26

(52) U.S. Cl. CPC G06Q 40/00; G06Q 50/265

(57) ABSTRACT

A method, non-transitory computer readable medium, and apparatus for verifying a validity of a communication from a fraud detection service are disclosed. For example, the method receives the communication from the fraud detection service indicating that a credit card number is associated with potentially fraudulent activity, provides a personal identification to the fraud detection service via a secured connection to request a confirmation that the communication is from the fraud detection service, wherein the personal identification is used to identify the credit card number and receives the confirmation that the communication is valid and was sent from the fraud detection service based upon a verification performed by the fraud detection service that compares the credit card number to a database containing a plurality of credit card numbers that are flagged for potentially fraudulent activity.

The present disclosure relates generally to fraud detection services and, more particularly, to a method and apparatus for verifying a validity of communication from a fraud detection service.

### BACKGROUND

One method of fraud on credit and debit cards is referred to as “phishing”. Phishing takes on a variety of guises, but the main goal is for the perpetrator to trick customers into revealing information which can be used to obtain access to the card. Once access to the cards is obtained, charges can be made, addresses can be changed, applications for new credit cards can be made, and so forth. Phishing methods include various types of communication that try to impersonate a bank or similar institution to obtain the customer's account information.

Currently, the credit and debit card companies handle this by trying to educate cardholders and telling the cardholders to call the credit card company if they suspect phishing. In the case of certain phishing methods, there may be factors such as the time of the day or the customer's location that provide a barrier for verification of the validity of the communication with a phone call to the card issuer. Therefore, much of the currently used methods dealing with phishing are reactionary and not proactive. Furthermore, currently used methods do not allow verification to be performed until after the communications is completed.

### SUMMARY

According to aspects illustrated herein, there are provided a method, a non-transitory computer readable medium, and an apparatus for verifying a validity of a communication from a fraud detection service. One disclosed feature of the embodiments is a method that receives the communication from the fraud detection service indicating that a credit card number is associated with potentially fraudulent activity, provides a personal identification to the fraud detection service via a secured connection to request a confirmation that the communication is from the fraud detection service, wherein the personal identification is used to identify the credit card number and receives the confirmation that the communication is valid and was sent from the fraud detection service based upon a verification performed by the fraud detection service that compares the credit card number to a database containing a plurality of credit card numbers that are flagged for potentially fraudulent activity.

Another disclosed feature of the embodiments is a non-transitory computer-readable medium having stored thereon a plurality of instructions, the plurality of instructions including instructions which, when executed by a processor, cause the processor to perform an operation that receives the communication from the fraud detection service indicating that a credit card number is associated with potentially fraudulent activity, provides a personal identification to the fraud detection service via a secured connection to request a confirmation that the communication is from the fraud detection service, wherein the personal identification is used to identify the credit card number and receives the confirmation that the communication is valid and was sent from the fraud detection service based upon a verification performed by the fraud detection service that compares the credit card number to a database containing a plurality of credit card numbers that are flagged for potentially fraudulent activity.

Another disclosed feature of the embodiments is an apparatus comprising a processor and a computer readable medium storing a plurality of instructions which, when executed by the processor, cause the processor to perform an operation that receives the communication from the fraud detection service indicating that a credit card number is associated with potentially fraudulent activity, provides a personal identification to the fraud detection service via a secured connection to request a confirmation that the communication is from the fraud detection service, wherein the personal identification is used to identify the credit card number and receives the confirmation that the communication is valid and was sent from the fraud detection service based upon a verification performed by the fraud detection service that compares the credit card number to a database containing a plurality of credit card numbers that are flagged for potentially fraudulent activity.

### BRIEF DESCRIPTION OF THE DRAWINGS

The teaching of the present disclosure can be readily understood by considering the following detailed description in conjunction with the accompanying drawings, in which:

FIG. 1 illustrates an example block diagram of a communication network of the present disclosure;

FIG. 2 illustrates an example flowchart of one embodiment of a method for verifying a validity of a communication from a fraud detection service from a perspective of an endpoint device;

FIG. 3 illustrates an example flowchart of one embodiment of a method for verifying a validity of a communication from a fraud detection service from a perspective of an application server of the fraud detection service; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for verifying a validity of a communication from a fraud detection service. As discussed above, one method of fraud on credit and debit cards is referred to as “phishing”. Phishing takes on a variety of guises, but the main goal is for the perpetrator to trick customers into revealing information which can be used to obtain access to the card.

Currently, the credit and debit card companies handle this by trying to educate cardholders and telling the cardholders to call the credit card company if they suspect phishing. In the case of certain phishing methods, there may be factors such as the time of the day or the customer's location that provide a barrier for verification of the validity of the communication with a phone call to the card issuer. Therefore, much of the currently used methods dealing with phishing are reactionary and not proactive. Furthermore, currently used methods do not allow verification to be performed until after the communications is completed.

One embodiment of the present disclosure addresses this problem by providing a method to allow users to securely contact the fraud detection service immediately when they receive a communication to verify that the communication is not a phishing attempt. In other words, the user may send the request for verification as the communication that was received is ongoing. Said another way, the user does not need to wait until after the communication is completed or received to send contact the fraud detection service for verification of the communication.

For example, a user may initiate a secure communication with the fraud detection services to confirm that the fraud detection services considers the user's card under suspicion of fraudulent activity and confirm that the communication was initiated by the fraud detection services. In one embodiment, the procedure may be fully automated via an application or a program that is executed or run on an endpoint device. As a result, no operators are needed and labor costs are reduced and the process is more efficient to provide a more satisfactory user experience.

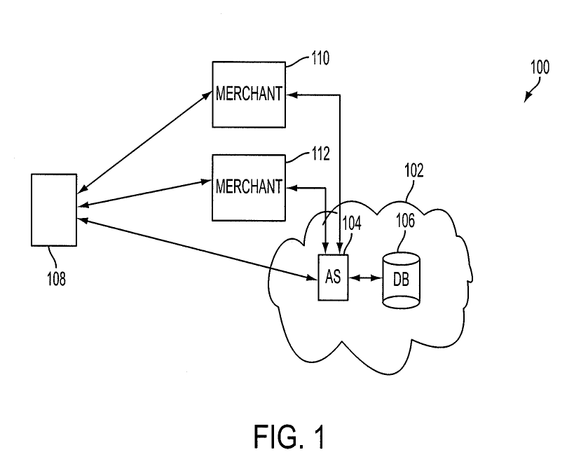

FIG. 1 illustrates an example communication network 100 of the present disclosure. In one embodiment, the communication network 100 may include a fraud detection service center 102, an endpoint device 108 and one or more merchants 110 and 112. Although only a single fraud detection service center 102, a single endpoint device 108 and two merchants 110 and 112 are illustrated in FIG. 1, it should be noted that any number of fraud detection services, endpoint devices and merchants may be deployed.

It should be also noted that the communication network 100 has been simplified for ease of explanation. For example, the communication network 100 may include additional networks and network elements not shown (e.g., additional access networks, border elements, gateways, communication towers, firewalls, servers, and the like).

In one embodiment, the endpoint device 108 may be any type of endpoint device capable of communicating with the merchants 110 and 112 and the fraud detection service center 102 via either a wired or wireless connection. For example, the endpoint device 108 may be a desktop computer, a laptop computer, a smartphone, a mobile telephone, a tablet computer, a landline telephone, a voice over Internet protocol (VoIP) telephone, and the like.

In one embodiment, merchant 110 and 112 may be any type of merchant. For example, the merchant 110 may be an online retailer and the merchant 112 may be a physical “bricks and mortar” retailer. The merchants 110 and 112 may be in communication with the fraud detection service center 102 or another financial institution (not shown) to authorize credit card/debit card transactions, transmit records of credit card/debit card transactions, and the like. For example, when a user goes online to the merchant 110 via the endpoint device 108 to make a credit card purchase, the merchant 110 may communicate with the fraud detection service center 102 to authorize the transaction. In one embodiment, the term credit card may be used herein broadly to also encompass debit cards.

In one embodiment, the fraud detection service center 102 may be a financial institution (e.g., a bank, a credit union, and the like) that issues the credit card and credit card number to users (e.g., the user of the endpoint device 108). For example, the fraud detection service center 102 may be a specialized department or branch of the financial institution.

In another embodiment, the fraud detection service center 102 may be a third party enterprise that is different and independent from the financial institutions that issues the credit card and credit card numbers to users. For example, the financial institutions may pay a fee to the fraud detection service center 102 to manage fraud detection for its customers.

In one embodiment, the fraud detection service center 102 may include an application server (AS) 104 and a database (DB) 106. In one embodiment, the AS 104 may perform the functions described herein (e.g., the fraud detection analysis, sending and receiving of communications to and from the endpoint device 108, generation of unique keys, and the like). In one embodiment, the DB 106 may store algorithms used for fraud detection or flagging credit card numbers for potentially fraudulent activity. For example, the algorithms may include analyzing transactions to identify purchases that do not follow a purchasing trend of the user, purchases in locations that are outside of a location of the user, purchases over a certain value, and the like. It should be noted that any algorithm may be used and the examples listed above are not intended to be limiting.

The DB 106 may also include a table that lists a plurality of credit card numbers that are flagged for potentially fraudulent activity. In one embodiment, the table may include columns to indicate that a communication was sent to the user. Such that when the user contacts the fraud detection service center 102 to request a confirmation of validity of a communication, the AS 104 can lookup whether the communication was sent for the particular credit card number. The table may also optionally include a column indicating an identification (ID) of one or more endpoint devices associated with an owner of the credit card number (e.g., a media access control (MAC) address), a column indicating whether a unique key has been generated and a column indicating the unique key.

Table 1 below illustrates an example table that could be used and stored in the DB 106.

TABLE 1
EXAMPLE CREDIT CARD NUMBER TABLE

| | | Communi- | | | |
|---|---|---|---|---|---|
| Credit Card | | cation | | Unique Key | Unique |
| Number | Flagged? | Sent? | ID | Generated? | Key |
| 1234-5678- | Y | Y | XYX, 333 | Y | Apple |
| 9123 | | | | | |
| 1234-5678- | Y | N | 123 | N | |
| 9124 | | | | | |
| 2234-5678- | N | N | 234 | N | |
| 9222 | | | | | |
| 2222-2222- | Y | Y | 245 | Y | Boat |
| 2222-2222 | | | | | |

In one embodiment, the endpoint device identification (e.g., the MAC address) column may be used to ensure that the request is coming from an authorized endpoint device 108 associated with a user. For example, this would prevent unauthorized users from attempting to steal and use the unique key for future communications that could be used for phishing attempts. For example, if a request is sent with the credit card number but from an unauthorized endpoint device, the fraud detection service center 102 may contact the user on an authorized endpoint device 108 to notify the user a request was sent from the unauthorized endpoint device. If the unauthorized endpoint device is owned by the user, the user may be provided an option to add the identification of the unauthorized endpoint device to the table for future communications.

In one embodiment, the unique key may be used to allow more efficient future communications with the fraud detection service center 102. For example, unique key may be an encrypted key for the authorized endpoint device that does not include any information relating to the credit card number or the user's account. The unique key can be included in any future communication to allow the user of the authorized endpoint device to know that the future communications are valid communications from the fraud detection service center 102 without requiring the user to send additional confirmation requests. The unique key may be a word, an image, and the like.

It should be noted that the columns illustrated in Table 1 are only examples. For example, the Table 1 may include additional columns such as an address, a telephone number, an email address, and the like of owners of the credit card numbers in the Table 1.

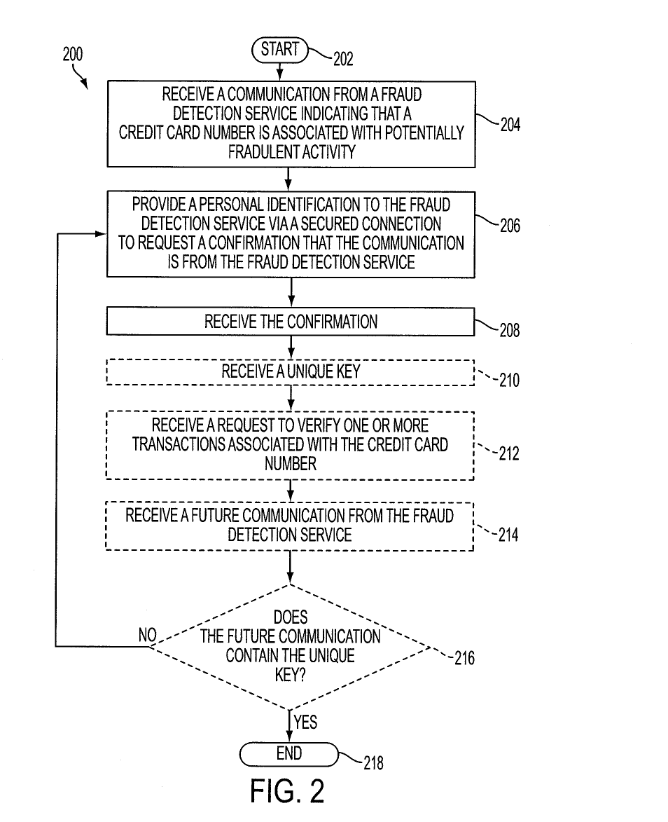

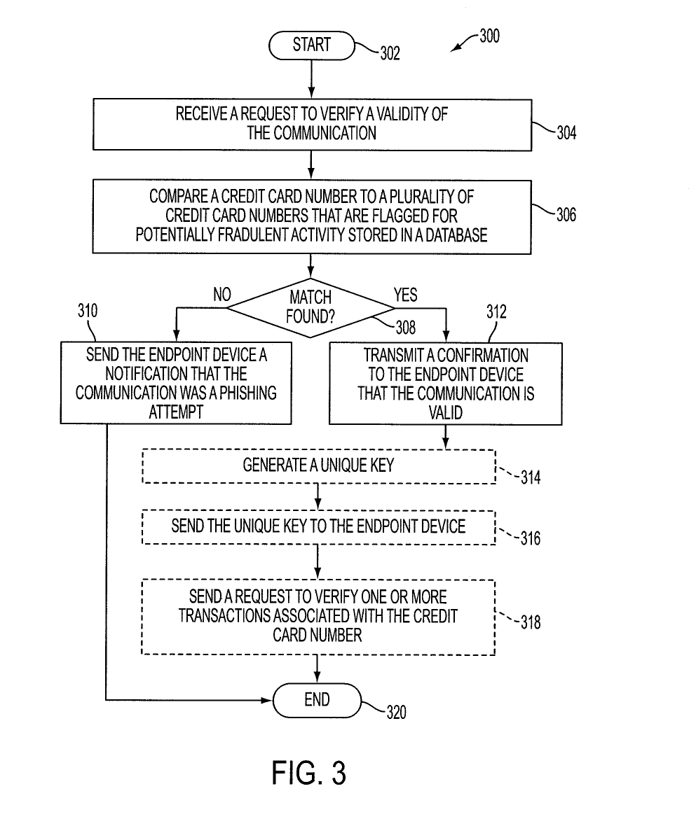

Using the fraud detection algorithms and the Table 1, the fraud detection service 102 may automatically notify users of potentially fraudulent activity. In addition, the users may use their endpoint device 108 to automatically request confirmation of a validity of the communication with the fraud detection service center 102 over a secured connection. In one embodiment, the confirmation may be sent using an application or program executed by the endpoint device 108. FIGS. 2 and 3 illustrate various embodiments for performing the method for verifying a validity of a communication from a fraud detection service.

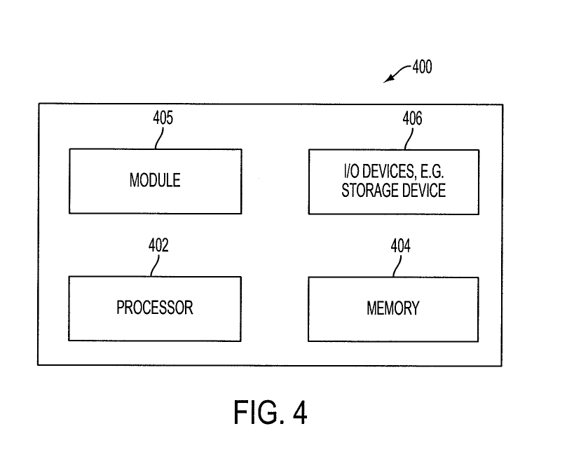

FIG. 2 illustrates a flowchart of a method 200 for verifying a validity of a communication from a fraud detection service. In one embodiment, one or more steps or operations of the method 200 may be performed by the endpoint 108 or a general-purpose computer as illustrated in FIG. 4 and discussed below.

At step 202 the method 200 begins. At step 204, the method 200 receives a communication from a fraud detection service indicating that a credit card number is associated with potentially fraudulent activity. The communication may be a telephone call, an email, or any other form of communication. When the user of an endpoint device receives the communication, the user may not be sure if the communication is a phishing attempt. In addition, if the communication is a telephone call, it may be difficult for the user to determine on the spot whether the communication is a valid communication from the fraud detection service.

In one embodiment, the fraud detection service may be a financial institution that issued the credit card number. For example, the fraud detection service may be a bank, a credit union, and the like.

In one embodiment, the potentially fraudulent activity may be detected using any known fraud detection algorithm currently used by financial institutions. Once a credit card number is flagged for potentially fraudulent activity, the fraud detection service may note the credit card number in a table stored in a database similar to the Table 1 described above.

At step 206, the method 200 provides a personal identification to the fraud detection service via a secured connection to request a confirmation that the communication is from the fraud detection service. In one embodiment, the personal identification may be the credit card number. In one embodiment, the user may manually enter the credit card number into the endpoint device via a user interface on the endpoint device. For example, an application may be run on the endpoint device that receives the credit card number and establishes a secure connection with the fraud detection service to transmit the credit card number.

In another embodiment, a photograph may be used to provide the credit card number. For example, the user may take a photograph of the credit card having the credit card number. The photograph may be sent to the fraud detection service over the secure connection. The fraud detection service may then use optical character recognition software to process the photograph and obtain the credit card number. Alternatively, the endpoint device may apply optical character recognition software to process the photograph, obtain the credit card number and communicate the credit card number securely to the fraud detection service.

In another embodiment, the personal identification may be any other form of information that allows the fraud detection service know the identity of the person sending the request and linking that person to the credit card number that is flagged. For example, other types of personal identification may include a name, an address, a date of birth, a social security number, a personal identification number (PIN), a password, a security question/answer, and the like. In one embodiment, more than one form of personal identification may be provided (e.g., the credit card number and the PIN).

In one embodiment, the secure connection may be an encrypted connection between an endpoint device of the user and the fraud detection service. The secure connection may be via a wired or wireless connection.

At step 208, the method 200 receives the confirmation. In one embodiment, once the fraud detection service receives the personal identification (e.g., the credit card number), the fraud detection center may compare the credit card number to a plurality of different credit card numbers that are flagged for potentially fraudulent activity stored in a table, e.g., Table 1 discussed above. The fraud detection center may perform verification by trying to find a match of the credit card number to one of the plurality of different credit card numbers. If a match is found, the fraud detection service may send the confirmation to the endpoint device of the user indicating that the communication that was received is a valid communication from the fraud detection service based upon the verification.

At optional step 210, the method 200 receives a unique key. In one embodiment, if a match of the credit card number to the plurality of different credit card numbers flagged for potentially fraudulent activity is found, then a unique key may be generated for the user. The unique key may be encrypted and be a key that contains no information about the credit card number or the user's account. However, the unique key would be different for each user and allow the user to quickly determine if any future communication from the fraud detection center is valid.

The unique key may be sent to the endpoint device of the user so that the user may know the unique key to look for any future communication. In one embodiment, the endpoint device may store the unique key and block any communication that attempts to use the name of the fraud detection service, but that does not include the unique key.

In one embodiment, the unique key may be automatically generated by the fraud detection service. In another embodiment, the unique key may be selected by the user. In one embodiment, the unique key may be a word or a picture.

At optional step 212, the method 200 receives a request to verify one or more transactions associated with the credit card number. In one embodiment, once the communication is confirmed to be a valid communication, the user may be asked to confirm that one or more transactions that caused the credit card number to be flagged for potentially fraudulent activity were initiated by the user. For example, a list of the transactions may be sent to the endpoint device of the user and the user may simply confirm or deny each transaction and the response may be sent back to the fraud detection service over the secure connection.

At optional step 214, the method 200 receives a future communication from the fraud detection service. In one embodiment, the fraud detection service may send one or more future communications to the endpoint device of the user. The future communication may include the unique key that was received at step 210.

At optional step 216, the method 200 determines if the future communication from the fraud detection service contains the unique key. If the future communication does not contain the key, the method 200 may return to step 206 to perform another verification of the communication. However, at optional step 216, if the future communication contains the unique key, then the user may be assured that the future communication is a valid communication from the fraud detection service. As a result, the user does not need to contact the fraud detection service to request a confirmation of a validity of the communication again. At step 218, the method 200 ends.

FIG. 3 illustrates a flowchart of a method 300 for verifying a validity of a communication from a fraud detection service. In one embodiment, one or more steps or operations of the method 300 may be performed by the AS 104 or a general-purpose computer as illustrated in FIG. 4 and discussed below.

At step 302 the method 300 begins. At step 304, the method 300 receives a request to verify a validity of the communication. For example, the user of the endpoint device may receive a communication and may send a request to the fraud detection service to verify the validity of the communication with a personal identification of the user that the fraud detection service can use to identify the credit card number of associated with the user. In other words, the user may send the request to the fraud detection service to ensure that the communication is not a phishing attempt. In one embodiment the communication may be a telephone call, an email, or any other form of communication.

The request may be received over a secured connection. In one embodiment, the secure connection may be an encrypted connection between an endpoint device of the user and the fraud detection service. The secure connection may be via a wired or wireless connection.

In one embodiment, the personal identification may be the credit card number. In one embodiment, the credit card number may be received as alpha numeric text that was manually entered by a user into his or her endpoint device. For example, the user may use the user interface of the endpoint device to manually enter the credit card number via an application or program that communicates with the fraud detection service over the secure connection.

In another embodiment, the credit card number may be obtained from a photograph of a credit card having the credit card number sent by the endpoint device of the user. The fraud detection service may use optical character recognition software to process the photograph and obtain the credit card number.

In another embodiment, the personal identification may be any other form of information that allows the fraud detection service to know the identity of the person sending the request and linking that person to the credit card number that is flagged. For example, other types of personal identification may include a name, an address, a date of birth, a social security number, a personal identification number (PIN), a password, a security question/answer, and the like. In one embodiment, more than one form of personal identification may be provided (e.g., the credit card number and the PIN).

At step 306, the method 300 compares a credit card number to a plurality of credit card numbers that are flagged for potentially fraudulent activity stored in a database. For example, the fraud detection service may store and maintain a table in a database that contains the plurality of credit card numbers that are flagged for potentially fraudulent activity.

At step 308, the method 300 determines if a match is found. If a match is not found, the method 300 may proceed to step 312. For example, the credit card number may not match. Alternatively, the table may include columns of additional information that is required to match. For example, the table may include a column indicating whether a communication was sent to the endpoint device associated with the credit card number that is flagged for potentially fraudulent activity. If the credit card number matches, but no communication was sent the communication may not be valid.

In one embodiment, the table may include a column storing one or more valid endpoint device IDs. For example, when the user applies for a credit card number the fraud detection center (or financial institution) may request the user register one or more endpoint devices that can be authorized to communicate with the fraud detection center. In one embodiment, the endpoint device identification may be a MAC address of the endpoint device.

As a result, if the request is from an endpoint device that does not match one of the endpoint device ID's in the table, the fraud detection service may notify the user that a suspicious endpoint device has attempted to contact the fraud detection service regarding his or her credit card number. In one embodiment, if the suspicious endpoint device is owned by the user that owns the credit card number, then the user may be provided an option to register the endpoint device ID of the new endpoint device.

At step 310, the method 300 sends the endpoint device a notification that the communication was a phishing attempt. The notification may include instructions to not respond to the communication and to forward the communication to the fraud detection services for analysis. The method 300 may proceed to step 320 where the method 300 ends.

Referring back to step 308, if a match is found the method 300 may proceed to step 312. For example, a match may be found if the credit card number matches one of the plurality of credit card numbers that are flagged for potentially fraudulent activity stored in the table. In one embodiment, the match may require that the table indicate that a communication was sent to the user. As a result, if the table indicates that a communication was sent and the credit card number matches, then communication that was received by the endpoint device may be verified as being valid.

In one embodiment, the match may also require that the request received at step 304 is from a valid endpoint device. As discussed above, the table may include a column that stores one or more valid endpoint device identifications.

At step 312, the method 300 transmits a confirmation to the endpoint device that the communication is valid. For example, a match was found and the confirmation let the user know that the communication was verified as being a valid communication from the fraud detection service.

At optional step 314, the method 300 may generate a unique key. In one embodiment, the unique key may be encrypted and be a key that contains no information about the credit card number or the user's account. However, the unique key would be different for each user and allow the user to quickly determine if any future communication from the fraud detection center is valid.

The unique key may be sent to the endpoint device of the user so that the user may know the unique key to look for any future communication. In one embodiment, the endpoint device may store the unique key and block any communication that attempts to use the name of the fraud detection service, but that does not include the unique key.

In one embodiment, the unique key may be automatically generated by the fraud detection service. In another embodiment, the unique key may be selected by the user. In one embodiment, the unique key may be a word or a picture.

At optional step 316, the method 300 may send the unique key to the endpoint device. For example, once the unique key is generated, the unique key may be sent to the endpoint device of the user over the secure communication.

At optional step 318, the method 300 may send a request to verify one or more transactions associated with the credit card number. In one embodiment, once the communication is confirmed to be a valid communication, the user may be asked to confirm that one or more transactions that caused the credit card number to be flagged for potentially fraudulent activity were initiated by the user. For example, a list of the transactions may be sent to the endpoint device of the user and the user may simply confirm or deny each transaction and the response may be sent back to the fraud detection service over the secure connection.

In one embodiment, if the one or more transactions are confirmed by the user then the respective credit card number may be removed as being associated with potentially fraudulent activity. For example, the flag may be reset to “N” in the example TABLE 1 or the credit card number may be deleted from the example TABLE 1, and the like. At step 320, the method 300 ends.

It should be noted that although not explicitly specified, one or more steps, functions, or operations of the methods 200 and 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIGS. 2 and 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises one or more hardware processor elements 402 (e.g., a central processing unit (CPU), a microprocessor, or a multi-core processor), a memory 404, e.g., random access memory (RAM) and/or read only memory (ROM), a module 405 for verifying a validity of a communication from a fraud detection service, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 405 for verifying a validity of a communication from a fraud detection service (e.g., a software program comprising computer-executable instructions) can be loaded into memory 404 and executed by hardware processor element 402 to implement the steps, functions or operations as discussed above in connection with the exemplary methods 200 and 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for verifying a validity of a communication from a fraud detection service (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for verifying a validity of a communication from a fraud detection service, comprising:
receiving, by a processor, the communication from the fraud detection service indicating that a credit card number is associated with a potentially fraudulent activity;
providing, by the processor, a personal identification to the fraud detection service via a secured connection to request a confirmation that the communication is from the fraud detection service, wherein the personal identification is used to identify the credit card number; and
receiving, by the processor, the confirmation that the communication is valid and was sent from the fraud detection service based upon a verification performed by the fraud detection service that compares the credit card number to a database containing a plurality of credit card numbers that are flagged for potentially fraudulent activity.

2. The method of claim 1, wherein the communication comprises a written communication.

3. The method of claim 1, wherein the communication comprises a telephone call.

4. The method of claim 1, further comprising:
receiving, by the processor, a unique key that is used to indicate a future communication is from the fraud detection service.

5. The method of claim 1, wherein the providing comprises providing a media access card (MAC) identification of an endpoint device to allow the fraud detection service to verify that the request is from the endpoint device that the communication was sent to.

6. The method of claim 1, wherein the providing comprises:
using, by the processor, a photograph to provide the credit card number.

7. The method of claim 1, wherein the providing comprises:
receiving, by the processor, the credit card number manually from a user via a user interface of an endpoint device; and
transmitting, by the processor, the credit card number to the fraud detection service.

8. The method of claim 1, further comprising:
receiving, by the processor, a request to verify one or more transactions associated with the credit card number.

9. A non-transitory computer-readable medium storing a plurality of instructions which, when executed by a processor, cause the processor to perform operations for verifying a validity of a communication from a fraud detection service, the operations comprising:
receiving the communication from the fraud detection service indicating that a credit card number is associated with a potentially fraudulent activity;
providing the credit card number to the fraud detection service via a secured connection to request a confirmation that the communication is from the fraud detection service; and
receiving the confirmation that the communication is valid and was sent from the fraud detection service based upon a verification performed by the fraud detection service that compares the credit card number to a database containing a plurality of credit card numbers that are flagged for potentially fraudulent activity.

10. The non-transitory computer-readable medium of claim 9, wherein the communication comprises a written communication.

11. The non-transitory computer-readable medium of claim 9, wherein the communication comprises a telephone call.

12. The non-transitory computer-readable medium of claim 9, further comprising:
receiving a unique key, wherein the unique key is included in future communications from the fraud detection service to indicate a validity of the future communications.

13. The non-transitory computer-readable medium of claim 9, wherein the providing comprises providing a media access card (MAC) identification of an endpoint device to allow the fraud detection service to verify that the request is from the endpoint device that the communication was sent to.

14. The non-transitory computer-readable medium of claim 9, wherein the providing comprises:
using a photograph to provide the credit card number.

15. The non-transitory computer-readable medium of claim 9, wherein the providing comprises:
receiving the credit card number manually from a user via a user interface of an endpoint device; and
transmitting the credit card number to the fraud detection service.

16. The non-transitory computer-readable medium of claim 9, further comprising:
receiving a request to verify one or more transactions associated with the credit card number.

17. A method for verifying a validity of a communication from a fraud detection service, comprising:
receiving, by a processor, a request to verify a validity of the communication sent to an endpoint device, wherein the request includes a personal identification used to identify a credit card number associated with a user;
comparing, by the processor, the credit card number to a plurality of credit card numbers that are flagged for potentially fraudulent activity stored in a database to verify that the communication was sent to the endpoint device regarding the potentially fraudulent activity associated with the credit card number, wherein each one of the plurality of credit card numbers each has a field in the database for a flag indicating whether a notification communication was sent; and
transmitting, by the processor, a confirmation to the endpoint device that the communication from the fraud detection service is valid when the credit card number matches one of the plurality of credit card numbers that are flagged for potentially fraudulent activity and has the flag indicating that the notification communication was sent.

18. The method of claim 17, wherein the communication comprises a written communication or a telephone call.

19. The method of claim 17, further comprising:
generating, by the processor, a unique key that is used to indicate a future communication is from the fraud detection service; and
sending, by the processor, the unique key to the endpoint device.

20. The method of claim 17, further comprising:
sending, by the processor, a request to verify one or more transactions associated with the credit card number
